(19) United States
(12) Patent Application Publication
(10) Pub. No.: US 2026/0156053 A1
(43) Pub. Date: Jun. 4, 2026

(54) NETWORK ASSISTED KPI BASED UAV FLIGHT PATH PLANNING AND MONITORING

(71) Applicant: INTERDIGITAL PATENT HOLDINGS, INC., Wilmington, DE (US)

(72) Inventors: Samir FERDI, Kirkland (CA); Guanzhou WANG, Brossard (CA); Taimoor ABBAS, Sainte-Julie (CA); Atle MONRAD, Froland (NO)

(73) Assignee: INTERDIGITAL PATENT HOLDINGS, INC, Wilmington, DE (US)

(21) Appl. No.: 19/126,307

(22) PCT Filed: Nov. 3, 2023
(86) PCT No.: PCT/US2023/078691

§ 371 Date: May 1, 2025

Related U.S. Application Data
(60) Provisional application No. 63/422,188, filed on Nov. 3, 2022.

(51) Int. Cl. H04L 41/5067; H04L 5/00; H04W 64/00; H04W 84/06

(52) U.S. Cl. CPC H04L 41/5067; H04L 5/0053; H04W 64/00; H04W 84/06

(57) ABSTRACT

Devices, methods and systems for flight path network data reporting. A request for an uncrewed aerial vehicle (UAV) flight path network data report that indicates at least one waypoint is received. A request for data analytics information regarding at least one UAV corresponding to the at least one waypoint is transmitted, responsive to the request for the UAV flight path network data report. Data analytics information regarding at least one UAV corresponding to the at least one waypoint is received, responsive to the request for data analytics information. A UAV flight path network data report is transmitted based on the data analytics information. In some implementations, the network device implements an uncrewed aerial systems Network Function (UAS-NF). In some implementations, the network device receives the request for a UAV flight path network data report from a UAS service supplier (USS).

### CROSS-REFERENCE TO RELATED APPLICATION

This application claims the benefit of U.S. Provisional Application No. 63/422,188, filed Nov. 3, 2022, the contents of which are incorporated herein by reference.

### BACKGROUND

Unmanned or uncrewed aerial vehicles (UAV) and other types of vehicles travel without an onboard human pilot. Accordingly, the position and/or heading of a UAV may obtained in various ways, e.g., to facilitate pilotless operation.

### SUMMARY

Some implementations provide a method implemented in a network device. A request for an uncrewed aerial vehicle (UAV) flight path network data report that indicates at least one waypoint is received. A request for data analytics information regarding at least one UAV corresponding to the at least one waypoint is transmitted, responsive to the request for the UAV flight path network data report. Data analytics information regarding at least one UAV corresponding to the at least one waypoint is received, responsive to the request for data analytics information. A UAV flight path network data report is transmitted based on the data analytics information.

In some implementations, the network device implements an uncrewed aerial systems Network Function (UAS-NF). In some implementations, the network device receives the request for a UAV flight path network data report from a UAS service supplier (USS). In some implementations, the network device transmits the request for data analytics information to another network device implementing a network data analytics function (NWDAF), implementing a data collection coordination function (DCCF), or implementing an analytical data repository function (ARDF). In some implementations, the data analytics information includes radio access network (RAN) or core network (CN) information. In some implementations, the data analytics information includes network status information, network load information, quality of service (QoS) information, or link quality information. In some implementations, the request for data analytics information includes key performance information (KPI) or UAV information. In some implementations, the network device transmits the UAV flight path network data report to a UAS service supplier (USS). In some implementations, the UAV flight path network data report includes UAV location information, key performance information (KPI), or flight route optimization information. In some implementations, the UAV flight path network data report includes information based on statistical information or core network (CN) predictive information.

Some implementations provide a network device. The network device includes circuitry configured to receive a request for an uncrewed aerial vehicle (UAV) flight path network data report that indicates at least one waypoint. The network device also includes circuitry configured to transmit, responsive to the request for the UAV flight path network data report, a request for data analytics information regarding at least one UAV corresponding to the at least one waypoint. The network device also includes circuitry configured to receive data analytics information regarding at least one UAV corresponding to the at least one waypoint, responsive to the request for data analytics information. The network device also includes circuitry configured to transmit a UAV flight path network data report based on the data analytics information.

In some implementations, the network device comprises circuitry configured to implement a UAS-NF. In some implementations, the network device comprises circuitry configured to receive the request for a UAV flight path network data report from a USS. In some implementations, the network device comprises circuitry configured to transmit the request for data analytics information to another network device implementing an NWDAF, implementing a DCCF, or implementing an ARDF. In some implementations, the data analytics information includes RAN or CN information. In some implementations, the data analytics information includes network status information, network load information, QoS information, or link quality information. In some implementations, the request for data analytics information includes KPI or UAV information. In some implementations, the network device comprises circuitry configured to transmit the UAV flight path network data report to a USS. In some implementations, the UAV flight path network data report includes UAV location information, KPI, or flight route optimization information. In some implementations, the UAV flight path network data report includes information based on statistical information or CN predictive information.

Some implementations provide a method implemented in a network device. A request is received for a UAV flight path network data report. A request for data analytics information is transmitted, responsive to the request for the UAV flight path network data report. Data analytics information is received, responsive to the request for data analytics information. A UAV flight path network data report is transmitted, based on the data analytics information.

In some implementations, the network device comprises circuitry configured to implement a UAS-NF. In some implementations, the network device comprises circuitry configured to receive the request for a UAV flight path network data report from a USS. In some implementations, the network device comprises circuitry configured to transmit the request for data analytics information to another network device implementing an NWDAF, implementing a DCCF, or implementing an ARDF. In some implementations, the data analytics information includes RAN or CN information. In some implementations, the data analytics information includes network status information, network load information, QoS information, or link quality information. In some implementations, the request for data analytics information includes KPI or UAV information. In some implementations, the network device comprises circuitry configured to transmit the UAV flight path network data report to a USS. In some implementations, the UAV flight path network data report includes UAV location information, KPI, or flight route optimization information. In some implementations, the UAV flight path network data report includes information based on statistical information or CN predictive information.

Some implementations provide a network device. The network device includes circuitry configured to receive a request for an uncrewed aerial vehicle (UAV) flight path network data report. The network device also includes circuitry configured to transmit, responsive to the request for the UAV flight path network data report, a request for data analytics information. The network device also includes circuitry configured to receive data analytics information, responsive to the request for data analytics information. The network device also includes circuitry configured to transmit a UAV flight path network data report based on the data analytics information.

In some implementations, the network device comprises circuitry configured to implement a UAS-NF. In some implementations, the network device comprises circuitry configured to receive the request for a UAV flight path network data report from a USS. In some implementations, the network device comprises circuitry configured to transmit the request for data analytics information to another network device implementing an NWDAF, implementing a DCCF, or implementing an ARDF. In some implementations, the data analytics information includes RAN or CN information. In some implementations, the data analytics information includes network status information, network load information, QoS information, or link quality information. In some implementations, the request for data analytics information includes KPI or UAV information. In some implementations, the network device comprises circuitry configured to transmit the UAV flight path network data report to a USS. In some implementations, the UAV flight path network data report includes UAV location information, KPI, or flight route optimization information. In some implementations, the UAV flight path network data report includes information based on statistical information or CN predictive information.

Some implementations provide systems, devices, and methods implemented in a unmanned aerial system application enabler (UAE) server for flight path quality of experience (QoE) reporting configuration. A flight path QoE reporting configuration request is received from an unmanned aerial vehicle service supplier (USS) server. A flight path QoE reporting configuration response is sent to the USS. A flight path QoE reporting configuration is executed. After successful execution of flight path QoE reporting configuration, a notification is sent to the USS indicating that the a flight path QoE reporting a configuration is complete.

Some implementations provide systems, devices, and methods for flight path quality of experience (QoE) reporting. A QoE report is received from a unmanned aerial system application enabler (UAE) client. UAE client current location information is requested from service enabler architecture layer (SEAL) location services. The UAE client current location information is received from the SEAL location services. A QoE report which includes location information is sent to a unmanned aerial vehicle service supplier (USS). Location report with QoE information is sent to the USS.

Some implementations provide systems, devices, and methods implemented in an uncrewed aerial systems network function (UAS-NF) for KPI based UAV Flight Path Exposure. A request for a KPI based UAV flight path report is received, by the UAS NF. One or more requests for data analytics collection are sent, by the UAS NF, to a data collection/analytics function (DCCF/NWDAF). The data analytics information is received by the UAS NF from the DCCF/NWDAF. A request to store analytics in an ADRF for subsequent USS requests is sent by the UAS NF. A UAV flight path report with KPI information is sent by the UAS NF to the USS.

Some implementations provide systems, devices, and methods implemented in a unmanned aerial system application enabler (UAE) server for quality of experience (QoE) based UAV flight path monitoring using a UAE layer. A unmanned aerial vehicle (UAV) QoE reporting configuration is received, by the UAE server, from a UAV service supplier (USS) server. The UAV QoE reporting configuration is sent by the UAE server to the UAE client. A QoE report is received, by the UAE server, from the UAE client. A request is sent, by the UAE server, for UAE client location information from service enabler architecture layer (SEAL) location services. The UAE client location information is received, by the UAE server, from the SEAL location services. A UAV QoE report with location information is sent to the USS.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a network diagram illustrating an example architecture for exposure of network performance data and/or flight path network KPI data;

FIG. 3 is a message sequence chart illustrating an example procedure for flight path network data reporting;

FIG. 4 is a message sequence chart which illustrates an example flight path QoE reporting configuration procedure;

FIG. 5 is a message sequence chart which illustrates an example flight path QoE reporting procedure; and

FIG. 6 is a flow chart illustrating an example process for servicing a request for a flight path network data report.

### DETAILED DESCRIPTION

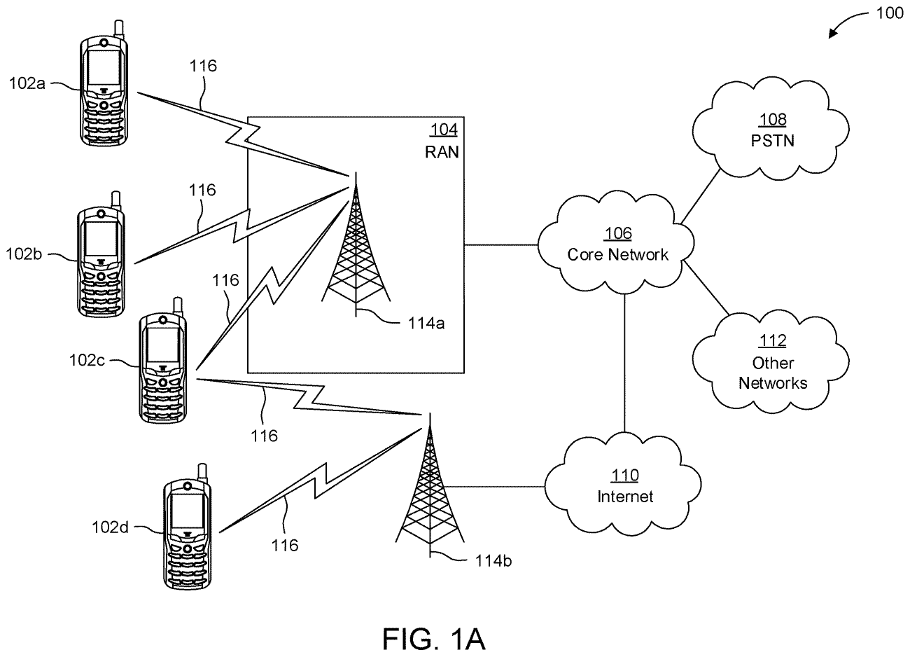

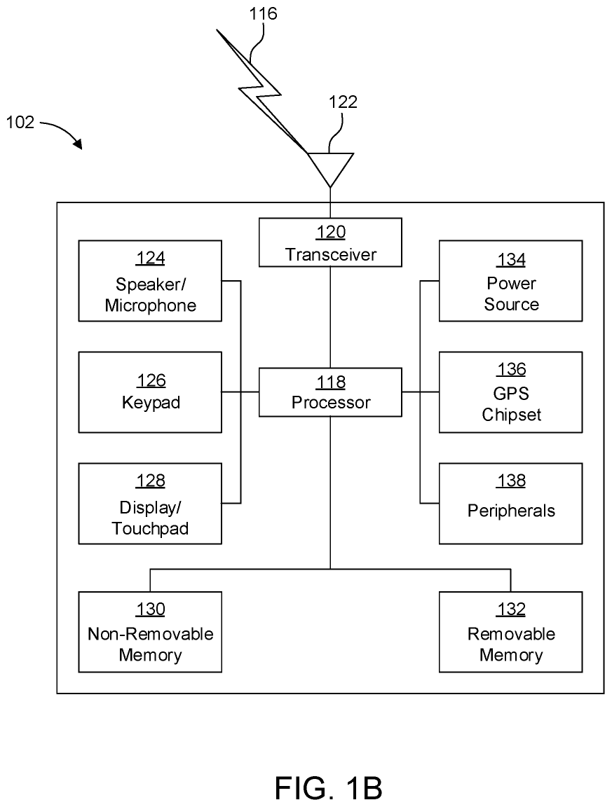

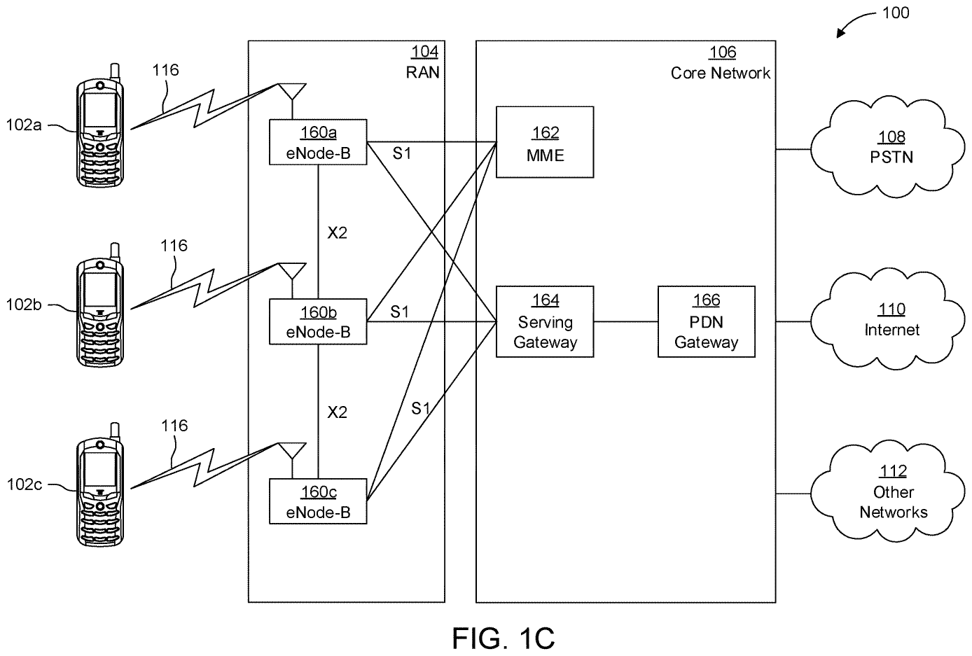

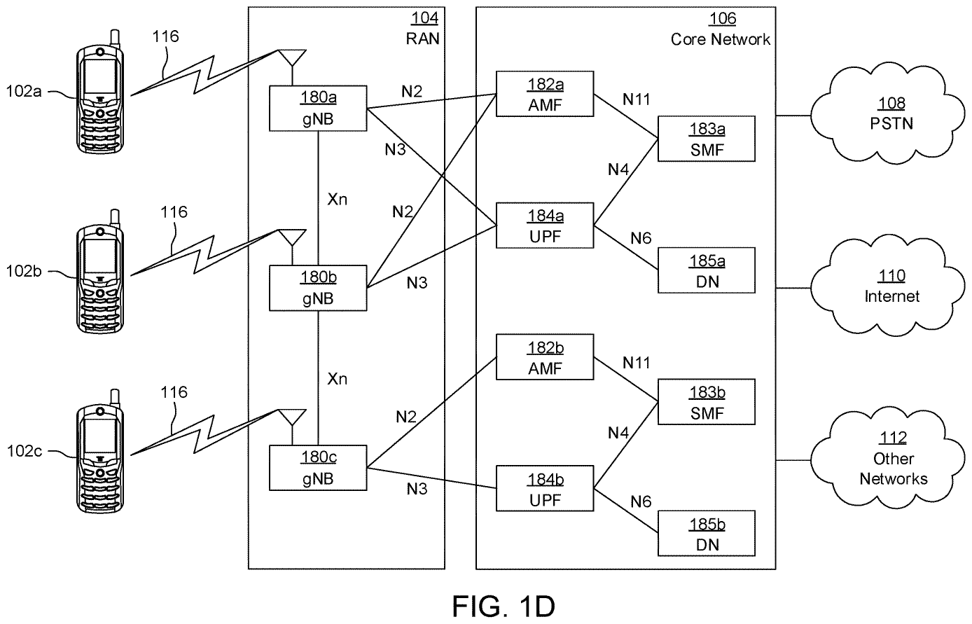

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like, The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms, among others, are used herein:
AF Application Function
ADRF Analytics Data Repository Function
BVLOS Beyond Visual Line of Sight
C2 Command and Control
DCCF Data Collection Coordination and Delivery Function
KPI Key Performance Indicator
LCS Location Services
ML Machine Learning
NEF Network Exposure Function
NF Network Function
NWDAF Network Data Analytics Function
OAM Operations, Administration and Maintenance
RSRP Reference Signal Received Power
RSRQ Reference Signal Received Quality
UAS Unmanned Aerial System
UAS NF Unmanned Aerial System Network Function (similar to NEF)
UAV Unmanned Aerial Vehicle
USS UAV Service Supplier
RSSI Received Signal Strength Indicator
RTT Round Trip Time
CQI Channel Quality Indicator
QoE Quality of Experience

3GPP introduced procedures and application programming interfaces (APIs) enabling a USS to track and monitor the location of UAVs in Rel-17. In some implementations, the USS (e.g., a server, which may be part of a Unmanned Aircraft System Traffic Management (UTM) system) may interface with a UAS NF directly, and/or use an application layer support API via a UAS application enabler (UAE) layer, and/or use a Service Enabler Architecture Layer (SEAL) API. In some implementations, the UAS NF obtains location information for a given UAV or group of UAV using LCS.

3GPP introduced communication performance requirements for UAV applications in Rel-17. In some implementations, the 5G system (5GS) is required to support various KPIs (e.g., QoS, minimum altitude, max ground speed) for a variety of UAV applications and command and control modes. For example in some implementations, a UAV with a “steer to waypoints” control mode or automatic flight on UTM capability may be classified as requiring, e.g., a 1 second end-to-end latency with a speed of up to 300 km/h, whereas in some implementations a “direct stick steering” mode may require, e.g., as little as 40 ms end-to-end latency with a much lower maximum speed.

3GPP introduced enhancements for LTE for the support of unmanned aerial vehicles (e.g., UAVs) in terms of interference mitigation and mobility. To address those requirements, support for a “flightPathInfoReport” feature was defined, enabling the transmission of height, location and speed information along with signal quality measurements from UAV/UE to eNB. Similar NR-specific enhancements may become part of Rel-18, e.g., based on previous work done in LTE.

3GPP added the support for network data analytics to 5GS in Rel-16. Functions which may be part of this framework include Network Data Analytics Function (NWDAF), Data Collection Coordination Function (DCCF), and Analytical Data Repository Function (ADRF).

In some implementations, NWDAF provides data analytics service in interaction with other NFs/NEF/OAM or AF. NWDAF provides support for data analytics collection and processing (e.g., statistical or predictive information derivation, ML model training).

In some implementations, DCCF provides data collection coordination and delivery to NF data consumers. Such functionality is also supported by NWDAF. DCCF provides support for collecting and formatting data from a NF data source (including ADRF below) to multiple NF consumers.

In some implementations, ADRF provides data and analytics storage service. ADRF stores, retrieves or deletes data/analytics based on consumer NFs requests.

The Aerial Connectivity Joint Activity (ACJA) initiative has defined a general mechanism referred to as “NetworkCoverage Service,” which describes high level principles for mobile network operators (MNO) to exchange network coverage/connectivity information with the UTM ecosystem.

In some implementations it may be desired to provide USS with network data (e.g., performance/KPI, status, load, coverage) for UAV flight path management. In some implementations, it may be desired to provide enhancements for UAV (e.g., as part of 3GPP Rel-19 ) with one or more of the following objectives: to provide additional information to the UAV operator/USS to execute pre-flight preparations and inflight operations (e.g., flight mission applications, flight path recommendations, flight monitoring and control, etc., and to support enhanced UAV flight/route management, e.g., based on network capacity and/or QoS information along a planned route.

Some implementations enable the USS to track the location of UAVs, but lack exposure to network performance and/or network status (e.g., coverage, QoS, signal level, etc.) related information, e.g., associated with an ongoing or planned UAV flight path and/or an area of interest.

In some implementations, such network metrics may be used by a USS as part of its flight path management operations (e.g., optimal flight path selection based on network provided info), e.g., to ensure the availability of reliable and performant connectivity for UAVs. Reliable connectivity is particularly crucial to ensure the safety and proper operations during BVLOS operations.

In some implementations, data analytics exposure may provide support for general purpose WTRUs (e.g., terrestrial WTRUs), e.g., by using various data within the 5GS, however system requirements for providing detailed network resources information adapted and relevant for UAVs flight path planning or monitoring have not been defined.

In some implementations, devices, systems, methods, and techniques described herein may advantageously provide exposure, to USS, of detailed network performance information (e.g., QoS, signal level) associated with a planned, ongoing, and/or past flight path or area of interest, e.g., based on predictions, statistical, and/or real time data.

Some such devices, systems, methods, and techniques may advantageously facilitate a USS to obtain (e.g., from the MNO) timely and accurate information about network coverage and performance. For example, in some implementations, the USS may collect network data for aerial operations to infer and recommend optimal flight route, flight scheduling and/or to adjust flight path as part of UAV flight control and monitoring.

In some implementations, the network advantageously enables storing and sharing network performance data among a network of USSs (e.g., federated network data). In other words, the network may maintain aggregated or federated flight path related network coverage or QoE metrics information, that the network may expose to one or more USSs. In some such implementations, the network leverages accumulated flight path network data, e.g., associated with several USSs, to construct a richer data set, and/or with wider coverage than would be possible with a single USS. This may have the advantage of improving network service added value. In some implementations, each USS benefits from an “economy of scale” using such federated network flight data, which may further improve the inference predictions (e.g., with better ML model fitting).

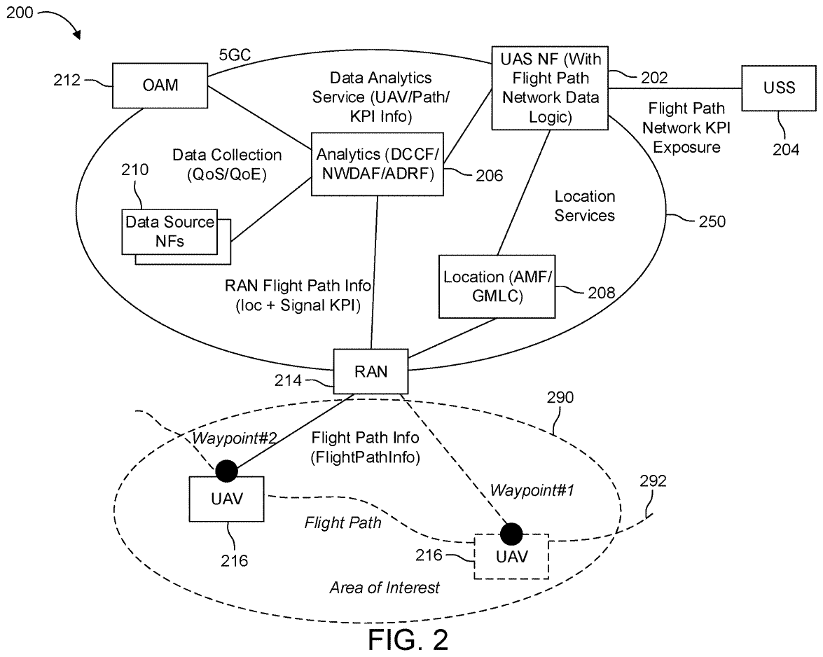

FIG. 2 is a network diagram illustrating an example architecture 200 for exposure of network performance data and/or flight path network KPI data. Example architecture 200 includes USS 204 and network 250. USS is a server in this example, however any suitable network equipment or other device for communication by a USS is usable in other implementations. Network 250 is a 3GPP 5G network or 5G core (5GC) in this example, however any suitable network is usable in other implementations.

Network 250 includes UAS NF 202, NWDAF/DCCF/ARDF 206, LCS 208, Data Source NF 210, OAM 212, RAN 214, and UE 216 in this example, however in other implementations, network 250 includes a subset of these devices, additional devices, and/or different devices.

In this example, UAS NF 202 is a server or other suitable network device or devices implementing a UAS NF.

NWDAF/DCCF/ARDF 206 is a server or other suitable network device or devices implementing a NWDAF, DCCF, and/or ARDF. Some implementations include a subset of these functions. In some implementations, these functions (or a subset of these functions) are implemented in the same device, in different devices, or in any combination across multiple devices. LCS 208 is a server or other suitable network device or devices implementing an LCS function. For example, in some implementations, LCS 208 is a device configured to provide information regarding a location of UE 216 (or in some implementations, any suitable WTRU, e.g., aboard or a part of any suitable vehicle, or uncrewed vehicle. Data Source NFs. Some examples of such NFs include: RAN node, Data Collection AF (DCAF), SMF, AMF, Management Data Analytics Function (MDAF) (e.g., to collect data from the OAM). 210 are servers (or a single server) or other suitable network device or devices implementing one or more Data Source NFs. OAM 212 is a server or other suitable network device or devices implementing one or more operations, administration, and/or maintenance functions (e.g., providing service experience/Quality of Experience (QoE) analytics, event/incident reporting and response). RAN 214 is or includes a radio access network or portions thereof. In this example RAN 214 includes a 5G RAN, however other implementations include one or more different RANs, or additional RANs. UE 216 is or is part of a UAV (e.g., a WTRU onboard a UAV), although in other implementations, UE 216 is or includes any suitable WTRU, and in some implementations, is aboard or a part of any suitable vehicle, or uncrewed vehicle.

In some implementations, UAS NF 202 provides an API or other interface for USS 204 (or other devices) to obtain network information associated with UE 216, such as network KPI or other network information, e.g., regarding flight path 292 or area of interest 290. In some implementations, the API may be an enhanced and/or augmented version of an existing API for UAV tracking and/or monitoring, e.g., as described herein regarding procedures and/or API (in some implementations, including new or existing procedures and/or API) for enabling a USS to track and monitor the location of UAVs, or using a dedicated API.

In some implementations, UAS NF 202 interfaces with one or more data analytics functions (e.g., NWDAF/DCCF/ARDF 206) to collect network KPI data based on a request from USS 204. In some implementations, the data analytics functions (e.g., NWDAF/DCCF/ARDF 206) interact with RAN 214 (e.g., via AMF) to collect information relating to a flight path of UE 216 (e.g., height, location, speed and signal quality information) and interact with other NFs (e.g., data source NFs 210, such as SMF, MDAF/OAM) to obtain QoS and/or QoE information (e.g., for an ongoing flight mission).

In some implementations, collected flight path network data may be stored, and may be later retrieved, e.g., via NWDAF/DCCF/ARDF 206 and/or other devices or functions. In some implementations, UAS NF 202 obtains location information regarding UE 216, e.g., from a location service such as LCS 208 (e.g., as described herein regarding UAV tracking and location monitoring.)

In some implementations, UAS NF 202 prepares and sends the network information and/or the location information to USS 204 based on the request (e.g., considering network data sharing policy). For example, if network data sharing is enabled among multiple USSs (i.e., network has a service level agreement with some federated USSs) the data collected by the UAS NF may result from the aggregation of data analytics compiled based on input from one or more USSs (e.g., using flight paths for UAVs belonging to different USSs). If network data sharing is not enabled the data collected by the UAS NF may be restricted to data analytics compiled based on input from the USS making the request (e.g., using flight paths information for UAVs belonging to the requesting USS).

Some implementations provide KPI based UAV Flight Path Exposure by UAS NF. For example, in some implementations, a UAS NF provides USS with exposure to network metrics and analytics associated with a given flight path and/or area of interest.

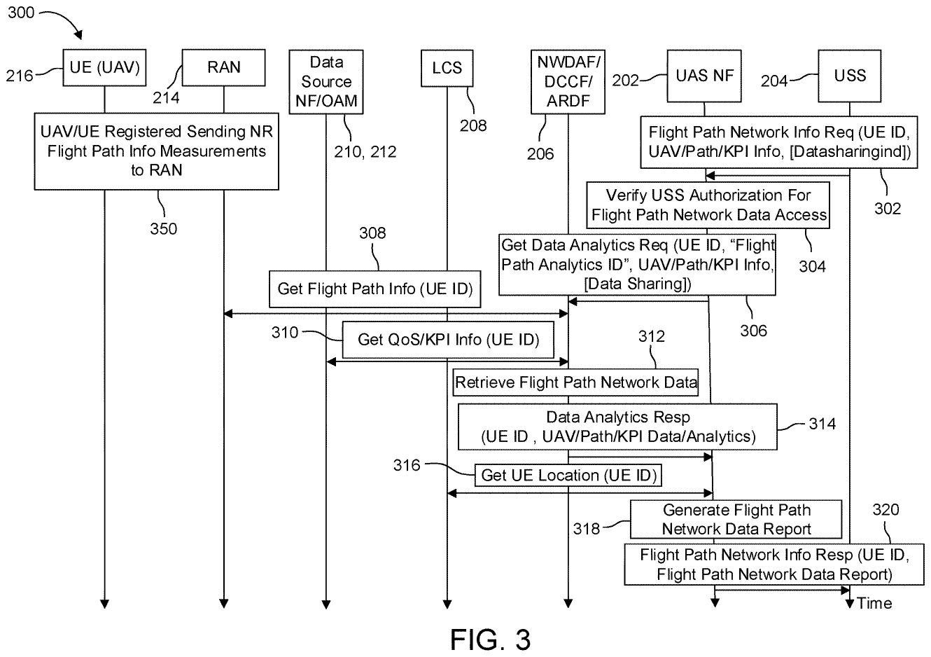

FIG. 3 is a message sequence chart illustrating an example procedure 300 for flight path network data reporting (e.g., UAV flight path network data reporting). In this example, procedure 300 is implemented by example architecture 200 as shown and described with respect to FIG. 2, however, it is noted that procedure 300, or parts thereof, are implementable by any other suitable hardware and/or architecture. In some implementations, aspects of flight path network data reporting illustrated by example procedure 300 are implementable by other suitable devices and/or other architectures. In this example, WTRU 216 (a UE and/or UAV in this example) is registered with RAN 214 in 350, and authorized to fly by the USS 204. In some implementations, WTRU 216 sends Flight Path Information measurements (e.g., NR Flight Path Information measurements) to RAN 214 nodes along its flight path.

In this example, the UAS NF 202 receives a request 302 for a flight path network data report (e.g., network QoS, network status, and/or network service experience, such as experienced WTRU/UAV responsiveness to C2 commands from the UAV Controller/pilot).

Request 302 may include an identification (e.g., UE ID) of UE 216, a UE/UAV class type, QoS/KPI thresholds and/or requirements, flight path network data analytics retention/sharing policy, UAV Application ID, flight path info and/or area of interest, reporting periodicity, validity scope (e.g., geographical area, time), and or other suitable information. The request may apply for on ongoing flight mission or to historical flight data or for historical/predictive network data (e.g., network coverage, capacity or load in an area) not associated with a particular flight.

In some implementations, the WTRU/UAV class type and/or Application ID may be used to derive reference KPI thresholds (e.g., RSSI, RTT, CQI) or QoS Profile or to filter out (e.g., UAVs only) analytics results as part of data analytics generation.

In example procedure 300, UAS NF 202 verifies that the USS 204 is authorized to obtain the requested network data (e.g., network data associated with an ongoing or past flight mission). In some implementations, the UAS NF 202 verifies that the USS is authorized to obtain the requested network data in verification 304. In some implementations, the USS 204 may be authorized based on a network data sharing policy (e.g., network data shared among several USSs) and/or based on a local configuration (e.g., based a local privacy regulation requirements). In some implementations, the UAS NF 202 may use the service of a PCF to determine the network data storage and/or sharing policy. In some implementations, the UAS NF 202 verifies that the USS 204 is authorized to obtain the requested network data responsive to request 302. In some implementations, UAS NF 202 verifies that the USS 204 is authorized to obtain the requested network data responsive to something else (e.g., responsive to a different request or other message, or a configuration), e.g., without receiving a request such as request 302. In some implementations, UAS NF 202 does not perform verification 304 or otherwise verify that the USS 204 is authorized to obtain the requested network data.

In some implementations, UAS NF 202 sends a request 306 (or multiple requests) for data analytics information to NWDAF/DCCF/ARDF 206. In some implementations, the requested data analytics information includes one or more of an identity (e.g., WTRU ID) of WTRU 216, WTRU class type (e.g., UAV class type) of WTRU 216, QoS and/or KPI requirements (e.g., that the network needs to provide along the given flight path) and/or thresholds (e.g., for the network to trigger the generation of a report), one or more areas of interest, WTRU (e.g., UAV) Application ID of an application running on WTRU 216, identifier for the requested analytics information (Analytics ID; e.g., “Service Experience”, “Flight path info”), and/or any other suitable information. In some implementations, request 306 specifies particular data analytics information that is requested by UAS NF 202 (e.g., from the information listed above). In some implementations, request 306 does not specify particular data analytics information.

In some implementations, request 306 (or another suitable indication from USA NF 202) indicates, or includes an indication for NWDAF/DCCF/ARDF 206 to store network data e.g., based on a data storing/sharing policy (e.g., received in request 302 or otherwise). In some implementations, request 306 includes network data collection reference information. In some implementations, such data collection reference information includes information identifying USS 204, storage and/or sharing rules, or any other suitable information. Network data collection reference information (e.g., reference identifier or number) may be provided by the UAS NF 202 to the USS in a response to a request 306. The network data collection reference information may be used by the UAS NF 202 to locate network data previously collected for the USS 204.

In some implementations, UAS NF 202 may send a request to a Unified Data Management service (UDM) providing expected behavior based on received WTRU/UAV class type, UAV application ID, target waypoints/trajectory. UAS NF 202 may translate some the parameters in request 306 into parameters provided to UDM. UDM stores that information for usage by data source NFs 210 (e.g. AMF, SMF). In some implementations, request 306 (or another suitable indication from USA NF 202) is also, or instead, sent to an entity other than NWDAF/DCCF/ARDF 206 In some implementations, the NWDAF/DCCF/ARDF 206 collects and/or initiates the collection of (and may receive) network data from RAN 214 (e.g., via AMF) collected for, from, and/or about WTRU 216, e.g., when collecting measurements received from WTRU 216 is in an active flight. In some implementations NWDAF/DCCF/ARDF 206 collects and/or initiates the collection of (and may receive) the network data via messaging 308 to or with RAN 214.

In some implementations, NWDAF/DCCF/ARDF 206 collects and/or initiates the collection of (and may receive) the network data responsive to request 306. In some implementations, NWDAF/DCCF/ARDF 206 collects and/or initiates the collection of (and may receive) the network data responsive to something other than request 306 (e.g., responsive to a different request or other message, or a configuration), e.g., without receiving a request such as request 306. In some implementations, NWDAF/DCCF/ARDF 206 does not collect and/or does not initiate the collection of the network data. For example, UAS_NF 202 may retrieve available historical collected data from NWDAF/DCCF/ARDF 206. In another example, data collection of network data may be performed by NWDAF/DCCF/ARDF 206 to retrieve near real time information of an ongoing flight or to add more recent measurements to maintain an up to date collected data.

In some implementations, data collected from RAN 214 (e.g., from or via a gNB of RAN 214) is based on aerial measurements of WTRU 216 (e.g., flightPathInfoReport measurements, Uplink/Downlink measurements, etc.). In some implementations, the NWDAF/DCCF/ARDF 206 generates and/or formats signal quality metrics (e.g., simplified signal level value 0-5) based on the data received from RAN 214 (e.g., in messaging 308). In some implementations, the signal quality metrics are generated and/or formatted such that the signal quality metrics are interpretable by USS 204 (e.g., when received in Flight path network data report 320 from UAS NF 202).

In some implementations, when collecting data or generating data analytics, NWDAF/DCCF/ARDF 206 may consider data that applies specifically to UAVs. For example, some experienced signal strength metrics (e.g., RSRQ/RSRP) may differ significantly when compared to “terrestrial” WTRUs and may negatively skew the accuracy of data analytics/predictions for the UAV, e.g., because the UAV/WTRU may come within range of and/or receive signals (e.g., more main lobes of transmission signals) from a greater number of cells while flying at certain altitudes. In some implementations, the WTRU/UAV class type and Application ID may also or alternatively be used to derive reference KPI thresholds (e.g., RSSI, RTT, CQI) or a QoS Profile used during data analytics generation and processing.

In some implementations, NWDAF/DCCF/ARDF 206 collects and/or initiates the collection of (and may receive) network data from one or more other data sources. For example, in some implementations, NWDAF/DCCF/ARDF 206 collects and/or initiates the collection of (and may receive) network data from data source NF's 210 and/or OAM 212 (e.g., when WTRU 216 is in an active flight). In some implementations NWDAF/DCCF/ARDF 206 collects and/or initiates the collection of (and may receive) the network data via messaging 310 to or with NF's 210 and/or OAM 212. In some implementations, the network data includes QoS data from an SMF and/or OAM 212.

In some implementations, NWDAF/DCCF/ARDF 206 collects and/or initiates the collection of (and may receive) the network data responsive to request 306. In some implementations, NWDAF/DCCF/ARDF 206 collects and/or initiates the collection of (and may receive) the network data responsive to something other than request 306 (e.g., responsive to a different request or other message, or a configuration), e.g., without receiving a request such as request 306. In some implementations, NWDAF/DCCF/ARDF 206 does not collect and/or does not initiate the collection of the network data.

In some implementations, NWDAF/DCCF/ARDF 206 stores collected and/or data generated by NWDAF based on collected data (e.g., received via messaging 310) in 312, e.g., based on a storage and/or sharing indication and/or policy (e.g., received in request 306 or otherwise).

In some implementations, NWDAF/DCCF/ARDF 206 retrieves network data, if available, from ARDF without collecting, initiating the collection of, or receiving the network data from RAN 214, data source NFs 210, and/or OAM 212 (e.g., messaging 308 and/or messaging 310 can be skipped if network data request is for historical data and/or not targeting real-time info of a specific UAV) based on sharing policy.. For example, if request 306 is for historical collected data and/or not for real time information of an ongoing flight, it may be retrieved directly from ARDF, if available.

In some implementations, UAS NF 202 receives the data analytics information from NWDAF/DCCF/ARDF 206 in response 314, or otherwise. In some implementations, UAS NF 202 receives the data analytics information from another source. In some implementations, the received data analytics information includes location information (e.g., corresponding to specific waypoints of the UAV from historical or ongoing flightpath). In some implementations, the location information is timestamped with RAN 214 and/or core 250 real time, and may include historical or predictive metrics (e.g., historical or predictive network status, load, indication of QoS, and/or link quality, etc.). In some implementations, the network data analytics may include an indication for an alternative flight path/route (e.g., alternative waypoints/locations or flight mission times offering better or optimal network performance).

In some implementations, UAS NF 202 may request and/or receive information regarding and/or indicating a location of WTRU 216 from LCS 208, e.g., in messaging 316 (e.g., to supplement and/or correlate with location information received in response 314).

In some implementations, UAS NF 202 generates, in 318, a response 320 to request 302. In some implementations, response 320 includes a flight path network data report. In some implementations, response 320 and/or the flight path network data report includes data analytics such as KPI, associated location information, and possible alternative locations/KPIs as received above. In some implementations, UAS NF 202 sends t the flight path network data report to USS 204 in response 320.

In some implementations, request 302 for flight path network data may be received by UAS NF 202 using a WTRU (UAV in this example) location tracking API (e.g., as part of an enhanced tracking and location monitoring procedure). In some implementations, USS 204 may request network data information for a list of WTRUs (UAVs in this example) in a given area of interest, such as area of interest 290 (e.g., without specifying a particular WTRU). In some implementations, UAS NF 202 may perform some or all of procedure 300 for a group of WTRUs (UAVs in this example) presently in that area of interest (e.g., which may be filtered based on UAV class type and/or whether the WTRU is owned, managed by, or otherwise associated with, USS 204, for example) or based on historical data for WTRUs (UAVs in this example) in that area. In some implementations, USS 204 may request network data information based on whether a UAV is present in a given area of interest (e.g., by monitoring the presence of the UAV). In some such cases UAS NF 202 may initiate the network data collection as described above for the WTRU (UAV in this example) responsive to being notified by LCS of the WTRU's presence in that area.

Some implementations provide application layer support for QoE-based UAV flight path monitoring. For example, some implementations include UAV flight path QoE reporting by a UAE layer. In some implementations, a UAE server reports location-based QoE metrics from a UAE client (e.g., UAV) to a USS based on a USS-provided flight path QoE reporting configuration. In some implementations, the UAE client reports QoS experienced by the UAV application layer to the USS via a UAE server according to USS set thresholds in a UAV flight path QoE reporting received from the USS via the UAE server (e.g., that the UAE client experienced packet delay greater than a delay threshold (e.g., set by the USS)).

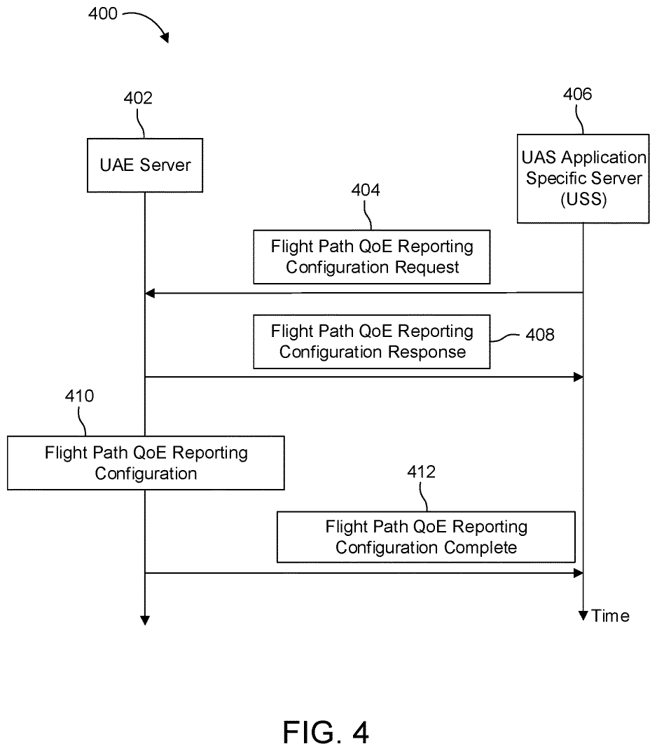

FIG. 4 is a message sequence chart which illustrates an example flight path QoE reporting configuration procedure 400. In this example, a UAE server 402 receives a request 404 from a UAS application-specific server 406 (e.g., a USS) for configuring fight path QoE reporting. In some implementations, UAE server 402 is a middleware server which resides between UAS application-specific server 406 and the 5G core. In some implementations, UAE server 402 may receive flight path QoE reporting configuration request 404 from USS server which may indicate and/or include QoE-related triggering event information (e.g., QoE thresholds, periodicity of collection of information such as QoE information), validity scope for where or when the reporting applies (e.g., flight path waypoints and/or geographical area, time), or any other suitable information.

In some implementations, UAE Server 402 may send a response 408 to UAS application-specific server 406 which may indicate and/or include the requested flight path QoE reporting configuration, and may indicate and/or include a positive or negative acknowledgement of the request. In some implementations, response 408 and/or its indication or contents may be based on whether UAE server 402 is capable of undertaking this task.

In some implementations, the UAE server may configure the UAE client with a flight path QoE reporting configuration 410 for the UAE client, e.g., by sending a configuration request to the UAE client. In some implementations, the UAE client comprises middleware running on the WTRU (e.g., UAV). In some implementations, this configuration request sent to the UAE client includes the WTRU (UAV in this example) identifier. In some implementations, this configuration request sent to the UAE client includes some or all of the QoE-related configuration information received in request 404. In some implementations, the UAE client may store the received QoE-related configuration parameters or other information, and may send a QoE reporting configuration response to the UAE Server 402.

After successful completion of the flight path QoE reporting configuration 410, UAE server 402 may notify UAS application-specific server 406, e.g., with a flight path QoE reporting configuration complete message 412.

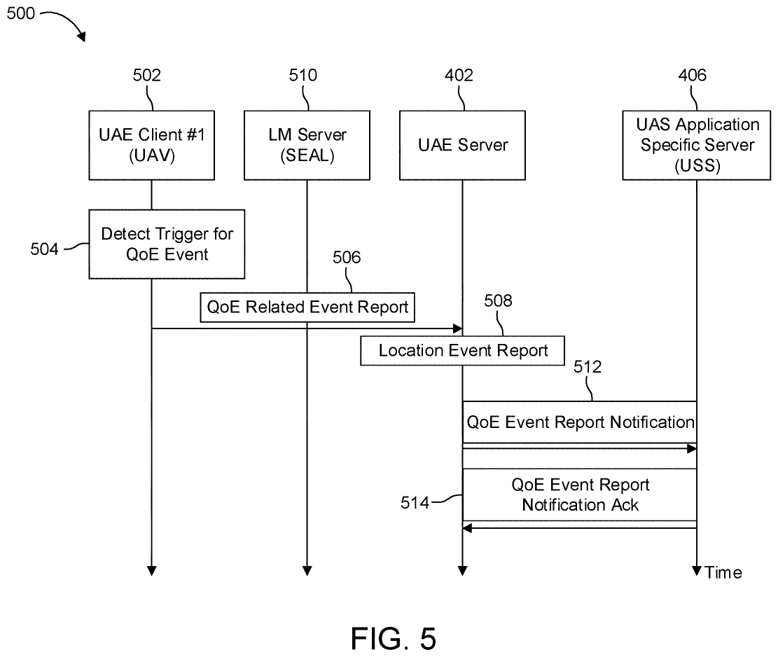

FIG. 5 is a message sequence chart which illustrates an example flight path QoE reporting procedure 500 where UAE server 402 processes QoE event reporting from a UAE client 502 and sends associated WTRU (UAV in this example) location information. to UAS application-specific server 406, e.g., in a consolidated fight path QoE Report.

In this example, UAE client 502 may detect a QoE event 504 (e.g., based on a metric, such as packet delay, exceeding a threshold). In some implementations, UAE client 502 detects a QoE event based on application-layer experienced QoS (e.g., packet delay and/or packet loss) and/or QoE thresholds from a previously stored QoE reporting configuration (e.g., flight path QoE reporting configuration 410 as shown in FIG. 4).

In some implementations, UAE server 402 may receive QoE-related event report 506 from the UAE client. In some implementations, report 506 includes or indicates information regarding QoE information (e.g., indicates low or high QoE). In some implementations, UAE server 402 records the event with a current timestamp.

In some implementations, UAE server 402 may request and receive, in 508, UAE client location information regarding UAE client 502, from SEAL location services server 510. In some implementations, UAE server 402 records the received location information with a current timestamp.

In some implementations, UAE server 402 may send, to UAS application-specific server 406, QoE report 512, which includes or indicates the QoE information and/or location information. In some implementations, e.g., based on the QoE reporting configuration, UAE server 402 may send QoE report 512 to UAS application-specific server 406 responsive to receiving the QoE information and/or location information, may send QoE report 512 to UAS application-specific server 406 periodically, and/or may send QoE report 512 to UAS application-specific server 406 responsive to the session between UAE server 406 and UAE client 502 ending (e.g., when the flight mission completes). In some implementations, UAS application-specific server 406 sends an acknowledgement 514 to UAE server 402 responsive to QoE report 512.

Some implementations provide KPI based UAV Flight Path Exposure by UAS NF and/or KPI based UAV flight path monitoring and planning. In the following example method, specific referenced details may be implemented, e.g., as discussed herein, e.g., regarding network assisted KPI based UAV flight path monitoring and planning.

In this example method, a UAS NF receives a request for a KPI based UAV flight path report (e.g., reporting a network QoS status and/or service experience associated with a flight path). In some implementations, the request includes a UAV identification and/or a WTRU/UAV class type, QoS/KPI thresholds and/or requirements, flight path network data analytics retention/sharing policy, UAV Application ID, flight path info and/or area of interest, reporting periodicity, validity scope (e.g., geographical area, time), and/or any other suitable information. The UAS NF sends one or more requests for data analytics collection to a data collection/analytics function (DCCF/NWDAF), the request or requests providing a WTRU ID, WTRU/UAV class type, QoS/KPI thresholds, area(s) of interest, UAV Application ID, Analytics id (e.g., “Service Experience”, “RAN flight path info”), and/or any other suitable information. The UAS NF receives the data analytics information from DCCF/NWDAF. In some implementations, the data analytics information includes timestamped location information with RAN and/or Core metrics (e.g., network status, load, indication of QoS, Link quality). The UAS NF requests to store analytics in an ADRF for subsequent USS requests, e.g., based on the flight path network data retention/sharing policy and/or based on local configuration. The UAS NF generates and sends, to USS, a UAV flight path report. In some implementations, the UAV flight path report includes UAV location information with associated KPI information and/or indication of flight route optimizations based on collected statistical data or predictions obtained from NWDAF/DCCF/ADRF, and/or any other suitable information.

Some implementations provide QoE based UAV flight path monitoring using a UAE layer. In the following example method, specific referenced details may be implemented, e.g., as discussed herein, e.g., regarding application layer support for QoE based UAV flight path monitoring.

In this example method, A UAE server receives a UAV QoE reporting configuration from USS server including QoE related triggering events (e.g., QoE thresholds, time/period to collect QoE information), validity scope (e.g., geographical area, time). The UAE server sends the UAV QoE reporting configuration to the UAE client. The UAE server receives a QoE report from the UAE client. In some implementations, the QoE report includes a QoE information (e.g., low/high QoE) and timestamp. The UAE server requests/receives UAE client location information from the SEAL location services. The UAE server generates and sends, to the USS, a UAV QoE report with location information. In some implementations, the location information includes network-based location information and/or associated UAV QoE information.

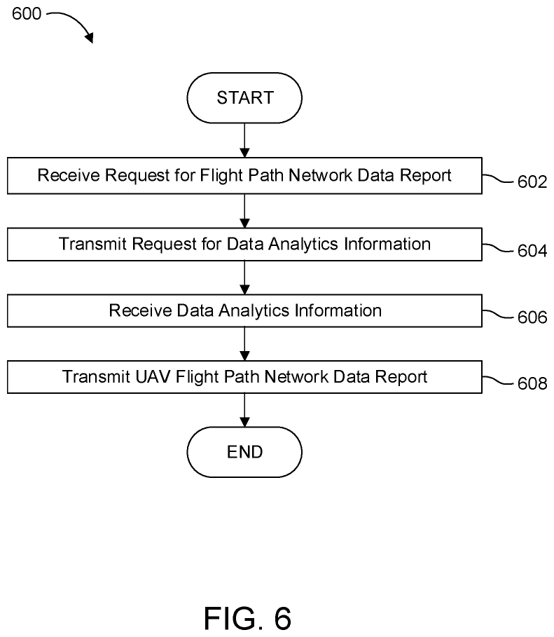

FIG. 6 is a flow chart illustrating an example process 600 for servicing a request for a flight path network data report. In some implementations, process 600 is implemented in a network device. In some implementations, the network device implements a UAS-NF (or other network device), and process 600 is implemented by, or using, this function.

In 602, a report request is received. In some implementations, the report request is, includes, indicates, or is based on a request for a UAV flight path network data report. In some implementations, the report is, includes, indicates, or is based on a request for a UAV flight path network data report that indicates at least one waypoint. In some implementations, the report request is received from a requestor device. In some implementations, the requestor device is or includes a USS.

In 604, a request for information is transmitted. In some implementations, the request for information is, includes, indicates, or is based on a request for data analytics information. In some implementations, the request for information is, includes, indicates, or is based on a request for data analytics information regarding at least one UAV corresponding to the at least one waypoint. In some implementations, the request for information is transmitted to one or more network devices implementing a NWDAF, DCCF, and/or ARDF.

In 606, the data analytics information is received. In some implementations, the data analytics information is received responsive to the request for data analytics information. In some implementations, the data analytics information is received from a one or more network devices implementing a NWDAF, DCCF, and/or ARDF. In some implementations, the data analytics information is, includes, indicates, or is based on RAN or CN information. In some implementations, the data analytics information is, includes, indicates, or is based on KPI and/or UAV information. In some implementations, the data analytics information is, includes, indicates, or is based on data analytics information regarding at least one UAV corresponding to the at least one waypoint, responsive to the request for data analytics information.

In 608, a flight path network data report is transmitted. In some implementations, the flight path network data report is transmitted to a USS. In some implementations, the flight path network data report is, includes, indicates, or is based on UAV location information, KPI information, and/or flight route optimization information, or information based on UAV location information. In some implementations, the flight path network data report is, includes, indicates, or is based on statistical information or CN predictive information, or information based on statistical information or CN predictive information. In some implementations, the flight path network data report is, includes, indicates, or is based on the data analytics information.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented in a network device, the method comprising:
receiving a flight path reporting configuration request, which indicates a flight path uncrewed aerial vehicle (UAV) quality of experience (QoE) reporting configuration, from a server device;
sending a flight path reporting client configuration request, based on the flight path UAV QoE reporting configuration, to a client device;
receiving a UAV QoE event report from the client device; and
sending a flight path UAV QoE report notification, which is based on the UAV QoE report, to the server device.

2. The method of claim 1, further comprising:
sending a request for client location information; and
receiving the client location information;
wherein the flight path UAV QoE report notification is also based on the client location information.

3. The method of claim 2, wherein the request for client location information is sent to a service enabler architecture layer (SEAL) location service, and the client location information is received from the SEAL location service.

4. The method of claim 1, wherein the flight path reporting configuration request indicates a triggering event.

5. The method of claim 1, wherein the flight path reporting configuration request indicates a quality of service (QoS) threshold, a QoE threshold, a periodicity of collection of QoS information, a periodicity of collection of QoE information, and/or scope information indicating a flight path, waypoint, geographical area, and/or time for which the reporting configuration is valid.

6. The method of claim 1, wherein the flight path reporting configuration request indicates a UAV identification (ID) and/or parameters from the server device.

7. The method of claim 1, wherein the UAV QoE event report indicates whether a QoE is high or low.

8. The method of claim 1, further comprising sending an indication of whether the flight path reporting client configuration request was successful.

9. The method of claim 1, further comprising sending an acknowledgement of the flight path reporting configuration request.

10. The method of claim 9, wherein the acknowledgement is based on a capability of the network device.

11. A network device comprising:
receiver circuitry configured to receive a flight path reporting configuration request, which indicates a flight path uncrewed aerial vehicle (UAV) quality of experience (QoE) reporting configuration, from a server device;
transmitter circuitry configured to send a flight path reporting client configuration request, based on the flight path UAV QoE reporting configuration, to a client device;
the receiver circuitry further configured to receive a UAV QoE event report from the client device; and
the transmitter circuitry further configured to send a flight path UAV QoE report notification, which is based on the UAV QoE report, to the server device.

12. The network device of claim 11, wherein:
the transmitter circuitry is further configured to send a request for client location information; and
the receiver circuitry is further configured to receive the client location information;
wherein the flight path UAV QoE report notification is also based on the client location information.

13. The network device of claim 12, wherein the transmitter circuitry is configured to send the request for client location information to a service enabler architecture layer (SEAL) location service, and the receiver circuitry is configured to receive the client location information from the SEAL location service.

14. The network device of claim 11, wherein the flight path reporting configuration request indicates a triggering event.

15. The network device of claim 11, wherein the flight path reporting configuration request indicates a quality of service (QoS) threshold, a QoE threshold, a periodicity of collection of QoS information, a periodicity of collection of QoE information, and/or scope information indicating a flight path, waypoint, geographical area, and/or time for which the reporting configuration is valid.

16. The network device of claim 11, wherein the flight path reporting configuration request indicates a UAV identification (ID) and/or parameters from the server device.

17. The network device of claim 11, wherein the UAV QoE event report indicates whether a QoE is high or low.

18. The network device of claim 11, wherein the transmitter circuitry is further configured to send an indication of whether the flight path reporting client configuration request was successful.

19. The network device of claim 11, wherein the transmitter circuitry is further configured to send an acknowledgement of the flight path reporting configuration request.

20. The network device of claim 19, wherein the acknowledgement is based on a capability of the network device.
